(19) United States
(12) Patent Application Publication
(10) Pub. No.: US 2003/0161450 A1
(43) Pub. Date: Aug. 28, 2003

(54) Providing information to facilitate telephone conversations

(76) Inventor: Edward O. Clapper, Tempe, AZ (US)

Correspondence Address: Timothy N. Trop, TROP, PRUNER & HU, P.C., STE. 100, 8554 KATY FWY, HOUSTON, TX, 77024-1841, US

(21) Appl. No.: 10/081,819

(22) Filed: Feb. 22, 2002

(51) Int. Cl. H04M 1/64

(52) U.S. Cl. 379/88.21

(57) ABSTRACT

A processor-based device automatically accesses a telephone number of a second party during an ongoing telephone call to retrieve and display extended data about the second party. In one embodiment, if this extended data is not available on a first database, the device may automatically initiate a search for the extended data on databases external to the device.

### BACKGROUND

This invention relates generally to processor-based systems.

Telephone call management software is available on a number of processor-based systems such as laptop and desktop computers. These applications work in conjunction with regular telephones or regular telephone service to facilitate automated call processing. For example, calls may be automatically implemented and information about callers may be recalled in connection with various telephone activities.

One problem that arises with these systems is that often the user may wish to use the telephone when the user's processor-based system is not powered up. The user may prefer to avoid the need to boot the system and the time involved in powering up the processor-based system in order to assist in making a telephone call.

In addition, in many cases, telephone conversations would be assisted by additional information. For example, if one party to a telephone call could acquire information about another party to the telephone call, this could be useful in facilitating the telephone conversation as well as in collecting information about known callers. This may be useful in personal and social situations as well as in a number of different business situations.

Thus, there is a need for better ways to facilitate telephone conversations and especially for better processor-based systems for doing so.

### BRIEF DESCRIPTION OF THE DRAWINGS

FIG. 1 is a schematic diagram of one embodiment of the invention;

FIG. 2 is a front elevational view of another embodiment of the present invention;

FIG. 3 is a depiction of a data structure that may be displayed for the user in response to a search query in one embodiment of the invention;

FIG. 4 is a flow chart for one embodiment of the invention;

FIG. 5 is a flow chart for another embodiment of the invention; and

FIG. 6 is a flow chart for one embodiment of the invention.

### DETAILED DESCRIPTION

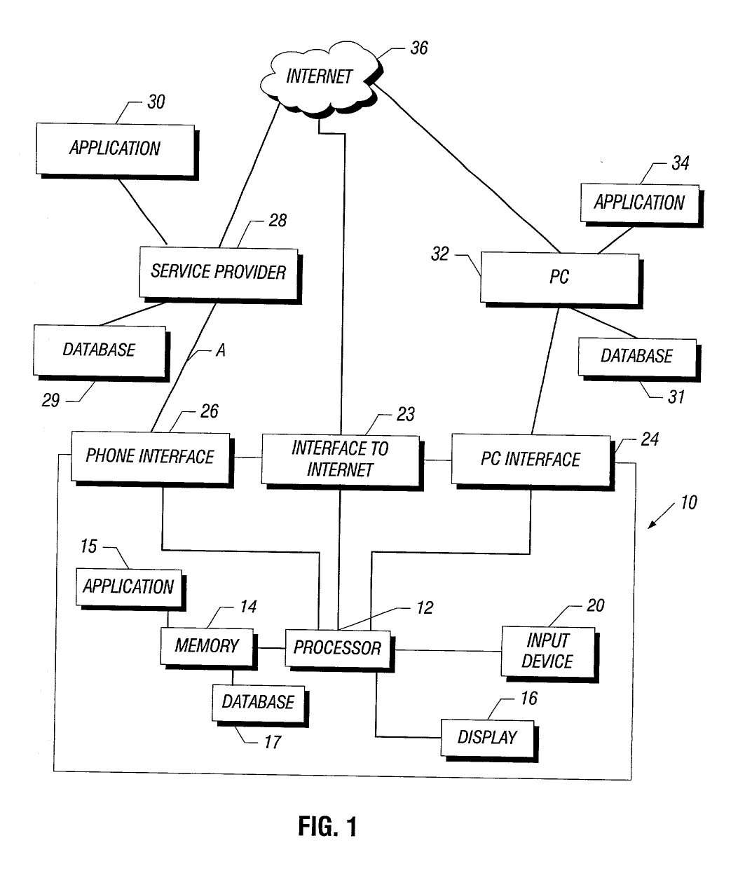

Referring to FIG. 1, a processor-based device 10 may include a processor 12 coupled to an input device 20 that may be a mouse, a keyboard, a touch screen or any of a plurality of known input devices. The processor 12 may also be coupled to a display 16. A memory 14, coupled to the processor 12, may store an application program 15 and a database 17 in accordance with one embodiment of the present invention. The processor 12 may also be coupled to an Internet interface 23, a personal computer or network interface 24 and a telephone interface 26.

The telephone interface 26 may be coupled by telephone line A to a telephone service provider 28. The telephone service provider 28 may include a processor-based system that stores an application 30 and a database 29. The service provider 28 may have its own connection to the Internet 36. Similarly, the interface 23 may couple to the Internet 36. The personal computer and network interface 24 may be coupled to a personal computer or network 32 as indicated in FIG. 1. The personal computer or network 32 may also include a memory that stores an application 34 and database 31 in one embodiment.

In one embodiment, the device 10 is a standalone processor-based system that may be owned by the same person who owns the personal computer or network 32. Thus, in such an embodiment, the device 10 may provide an adjunct to the personal computer or network 32 that may be useful in connection with the facilitating telephone conversations.

The application program 15 stored in the memory 14 may control the operation of the device 10. The application program 15 may perform several functions, including receiving user commands through the input device 20 and communicating with the user through the display 16. The application 15 may enable the user to view, search or modify the information stored on the database 17. Further, it may enable the device 10 to communicate and exchange data with other devices to which it may be coupled.

The device 10 may communicate in either a wired or wireless mode with a personal computer or network 32 through an interface 24. The personal computer or network 32 may include a database 31 and may be coupled to the Internet 36. An application 34 on the personal computer or network 32 may manage its operation, including communication with the device 10 and the Internet 36. Although the device 10 may exchange information with the personal computer or network 32, the device 10 may be operated by the user independently of the personal computer or network 32.

The device 10 may include a phone interface 26 that enables access to a phone line “A”. Further, in some embodiments the phone line A may be coupled to a remote service provider 28 that may have access to a database 29. An application 30 at the service provider 28 may manage communication and data transfer between the service provider 28 and either the device 10 or the Internet 36. In one embodiment, the service provider 28 may be a telephone company access point or switching station.

In response to a search query, the application 15 may obtain information of interest from the database 17 on the device 10. If the information of interest is not found in the database 17, the application 15 may search for this information by accessing information from remote sources. In one example, the remote sources may include the personal computer or network 32, a service provider 28 and the Internet 36. The information sources available for the search include the database 31 on the personal computer or network 32, the database 29 on the service provider 28 and the Internet 36. The order in which these information sources may be searched is governed by a user preference table stored in the memory 14 on the device 10 in one embodiment. The application 15 may initially prompt the user to complete the user preference table.

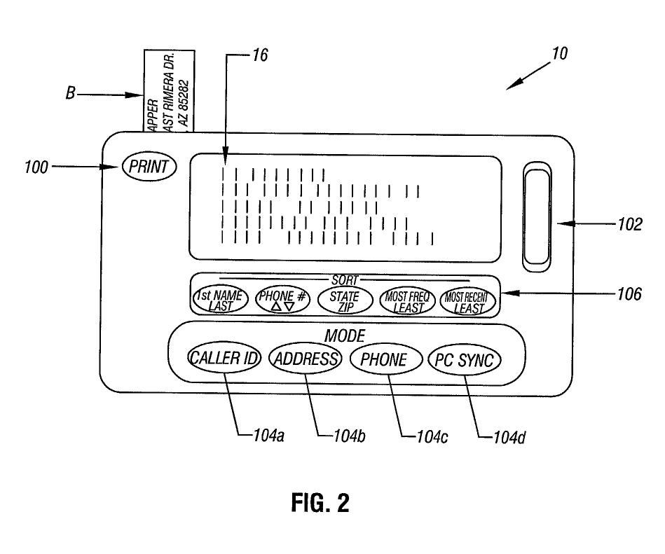

Referring to FIG. 2, in accordance with one embodiment of the present invention, the device 10 may be a portable or battery powered device that is connectable to a remote personal computer or network 32. Thus, for example, the device 10 may be turned on and may be operational at times when the personal computer or network 32 is not operational. In addition, the device 10 may enjoy a more rapid boot-up routine, in some embodiments, for example, using an embedded controller. The front face of the device 10 may include a button 100 to facilitate printing of address labels indicated at B in FIG. 2. The display 16 may display a record associated with a search inquiry, for example, when a telephone call is made or received. A scroll wheel 102 may be utilized to scroll the display 16.

In some embodiments, a plurality of mode buttons 104 may be provided including a caller identification mode button 104a, an address mode button 104b, a phone mode button 104c, and a personal computer synchronization button 104d. The caller identification button enables the device 10 to display caller identification information and likewise the address button enables the display 16 to display address information. The phone button also allows the display of phone information and the synchronization button may be utilized to synchronize the personal computer and network 32. Synchronization may be needed to provide information to or from the device 10, such as newly obtained information. As described in more detail hereinafter, the device 10 may initiate searches on external systems and that information may be stored in a database associated with the device 10. The stored information may also be shared or synchronized with the personal computer or network 32 in some embodiments.

A record sorting bar 106 may be provided to sort the displayed information by first name, phone number, state zip code, most frequent or least frequent, or most recent or least recent, as indicated in FIG. 2. Of course, the embodiment shown in FIG. 2 is only an example of the types of interfaces that may be utilized with the device 10.

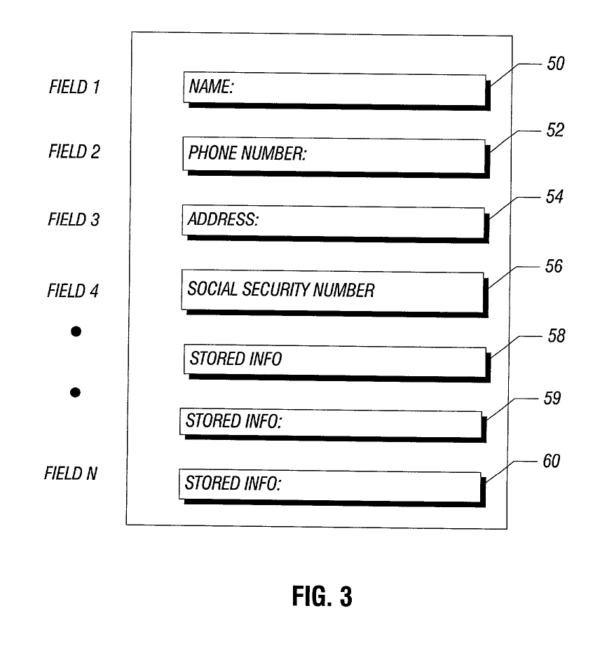

In one embodiment, the information retrieved by the application 15 as a result of a search may be organized in several fields indicated by blocks 50, 52, 54, 56, 58, 59 and 60 of FIG. 3. One or more of these fields may include seed data that uniquely identifies the subject of the search query. When a person is the subject of a search query, the seed data may include the name, phone number, and other information, such as address and social security number of that person, all displayed in blocks 50, 52, 54 and 56 in one example.

A user may request extended data relating to a subject identified by the seed data. This extended data is displayed in blocks 58, 59 and 60 in this example. When the subject of the search is a person, the extended data fields may include any information of interest to the user of the device 10, who may wish to use the seed data and extended data to facilitate communication with his or her list of business or social contacts, relations or friends, as examples. The extended data may include such things as the subject's birthday, anniversary, or the name of the subject's employer and the subject's title. After the search, the application 15 may display both the seed data and the extended data to the user on the display 16.

In those embodiments in which the device 10 is coupled to a phone line A, an incoming or outgoing phone call may automatically access seed data that uniquely identifies the other party involved in the call. In the case of an outgoing call, the identifying information may include the phone number being called. In the case of an incoming call, the seed data may be Caller Identification (caller ID) information, as a service from the applicable phone service provider. Typically caller ID information includes the phone number and name of the calling party.

This seed data identifying information about the other party to a call may also be compiled in sequence to generate a call history for incoming and outgoing calls. The application 15 may store this call history in the memory 14 on the device 10 and allow the user to view, search or modify the history. Further, the application 15 may transfer the call history to other devices to which the device 10 may be coupled.

In those embodiments in which device 10 is coupled to a phone line, an incoming or outgoing phone call may cause the application 15 to automatically initiate a search query for extended data about the other party to the phone call. The search may be initiated based on the seed data identifying the other party since the seed data is automatically generated as a result of making or receiving the call.

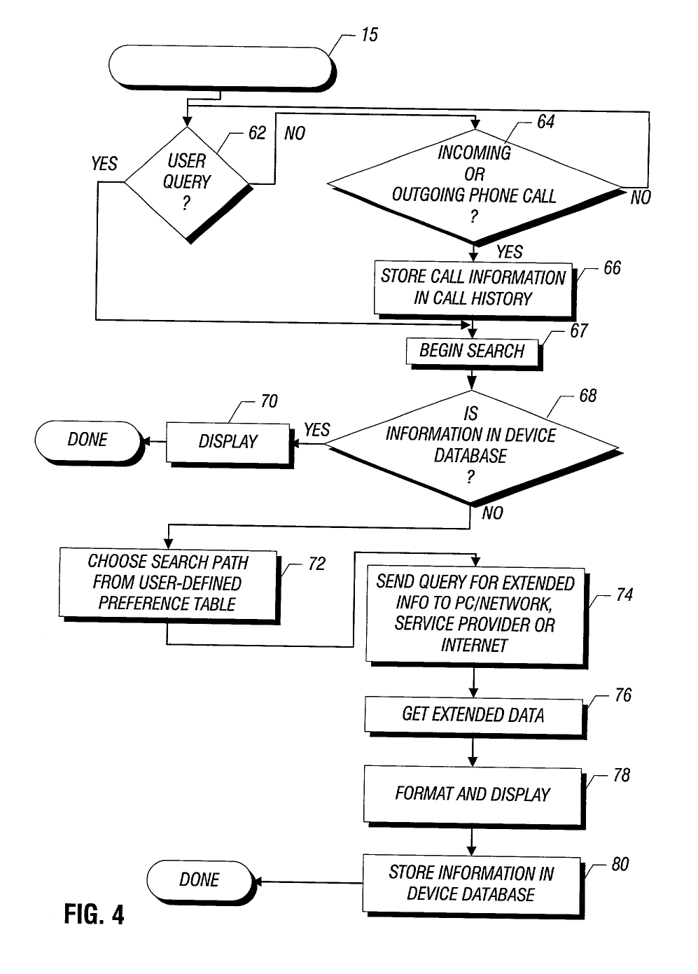

The application 15, shown in FIG. 4, may begin with either a user search query or the automatic generation of data when a telephone call is commenced. A user initiated search query is detected at diamond 62.

Alternatively, an incoming or outgoing phone call may automatically generate seed data used to initiate a search for extended data about the other party involved in the call. If a call is identified in diamond 64 the call may be added to the call history as indicated in block 66.

Using the automatically generated seed data, the application 15 may begin the search for extended data in the local database 17 stored in the device 10 as shown in block 67. If the information of interest is found in this local database 17, as determined at diamond 68, the extended data is displayed on the display 16 as shown in block 70.

However, if extended data is not found in the database 17, in one embodiment, the user preference table is consulted to determine how to proceed, as indicated in block 72. In one example, when the desired information is not available in the database 17 on the device 10, the user preference table may indicate that the next search be directed to the personal computer or network 32 through the interface 24. In this case a search query including the appropriate seed data may be forwarded to the application 34 on the personal computer or network 32 as shown in block 74.

Similarly, in a second example, when the user preference table indicates that the search should subsequently proceed on the service provider 28, the application 15 may communicate with the application 30 on the service provider 28 over the line A. A search query and the seed data may be transferred to the service provider's application 30 from the application 15 on the device 10. The service provider 28 initiates a search on the database 29.

In a third example, in those cases when the information of interest is not available on the database 17 on the device 10, the user preference table may indicate to search the Internet 36. In this case, an Internet search is formulated and transmitted through the interface 23, as indicated in block 74 of FIG. 4.

After communicating its search query to one of the devices connected to the device 10, the device 10 may receive extended data as indicated in block 76. The extended data may be displayed on the display 16 as indicated in block 78. Further, the extended data may be added to the database 17 on the device 10 as shown in block 80 in order to update the database. Thus, the database 17 may grow as the result of extended searches so that, subsequently, that extended data will be more readily accessible from the device 10.

The application 34 on the personal computer or network 32 may perform many functions similar to those performed by the application 15 on the device 10, including searching or modifying the local database, and communicating with the software routines on other devices coupled to the device on which it is installed. Further, the application 30 which controls the operation of the service provider 28 may have these same features.

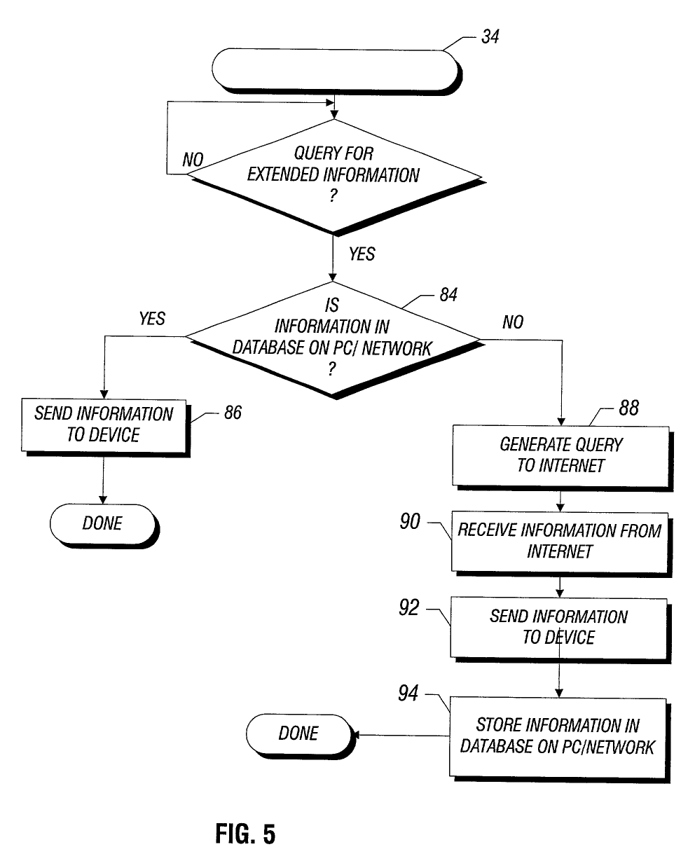

In one embodiment of the application 34 on the personal computer or network 32, illustrated in FIG. 5, when a search query may be received from the application 15 managing the device 10 as shown in block 82. Initially, a search for the extended data is implemented on the database 31 of the personal computer or network 32 as indicated in block 84. If the extended data is found, as determined in diamond 84, the information is sent back to the device 10 through the interface 24 as indicated in block 86.

If, however, the information is not available on the database 31 of the personal computer or network 32, the application 34 may automatically generate a search query to the Internet 36 as shown in block 88. When the extended data is received as a result of this search, the application 34 may format the data and send it to the device 10 through the interface 24, as indicated in block 92. Further, the application 34 may incorporate the extended data into the database 31 on the personal computer or network 32 as shown in block 94 in some embodiments.

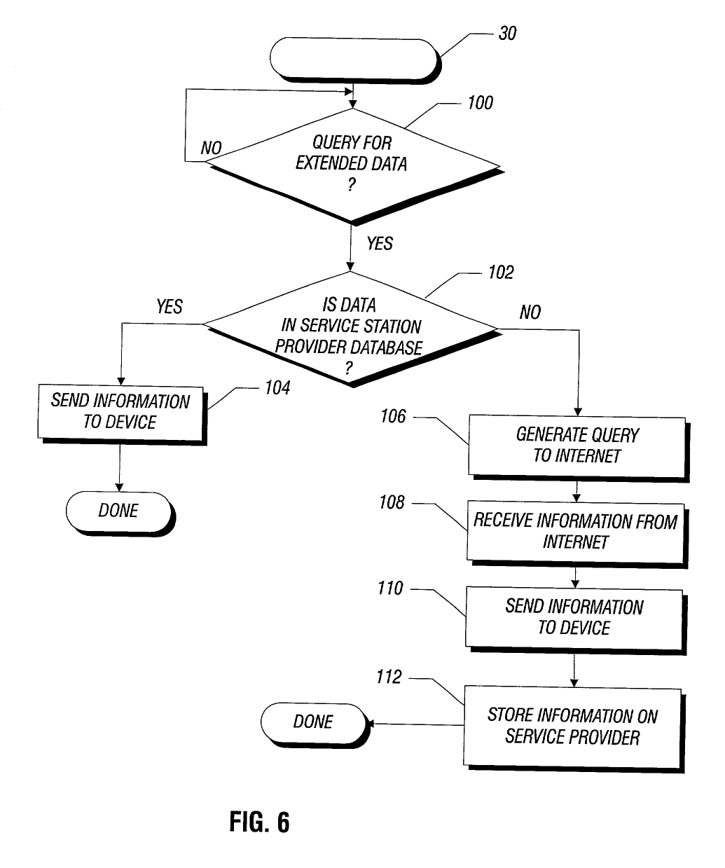

In some instances the application 15 on the device 10 may be directed by the user-defined preference table to direct the search to the service provider 28. In this case the device 10 communicates with the application 30 that manages the operation of the service provider 28. In one embodiment, the application 30, illustrated in FIG. 6, may receive a search query, as shown in block 100, from the device 10, along with seed data (which may include the phone number of an outgoing call or Caller ID information for an incoming call).

The application 30 may initially search the local database 29 on the service provider 28 for extended data as shown in diamond 102. If the desired information is found, it is transferred to the device 10, as indicated in block 104. However, if this information is not found on the local database 29, a search is automatically initiated over the Internet 36 as indicated in block 106. The extended data received as a result of this search (block 108) may be sent to the device 10 as indicated in block 110. Further, in some embodiments, the extended data may also be incorporated into the local database 29 on the service provider 28, as shown in block 112.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
enabling automatic access to a telephone number associated with a second party during a telephone call;
enabling access to a first database in a first system, said first database storing multiple records, each including a name, a telephone number and other information; and
enabling the telephone number to be used to locate in said database a record for said second party.

2. The method of claim 1 including enabling the system to automatically initiate a search in a second database for information related to said record.

3. The method of claim 2 including locating said second database external to said first system in a second system with a second application.

4. The method of claim 3 including enabling the first system to transmit a search query to said second system and to receive search results from said second system.

5. The method of claim 3 including enabling the first system to store information in said first database found in said second database.

6. The method of claim 2 including selecting said second database from a plurality of databases.

7. The method of claim 6 including enabling a user preference table to be stored in association with said first database which indicates a preferred search hierarchy among said plurality of databases.

8. The method of claim 1 including enabling the first system to store a sequential listing of telephone numbers of outgoing telephone calls and caller identification information for incoming telephone calls.

9. A system comprising:
a processor;
a storage associated with said processor to store a first database with a plurality of records, each containing a telephone number, a name and other information; and
an application stored in said storage that enables said processor to access the telephone number of a second party to an ongoing telephone call, search said first database for a record containing said telephone number, and display a name, telephone number and other information associated with said record.

10. The system of claim 9 wherein said application automatically initiates a search for information related to said record in a second database.

11. The system of claim 10 wherein said application transmits a search query and receives search results to obtain extended data related to said record in a database external to said system.

12. The system of claim 11 wherein if said information is found in said external database, said application automatically stores said information in said first database.

13. The system of claim 13 wherein said storage stores a user preference table that indicates a preferred search hierarchy among a plurality of databases.

14. The system of claim 9 wherein said storage stores a sequential listing of telephone numbers of outgoing telephone calls and caller identification information for incoming telephone calls.

15. An article comprising a medium storing instructions that enable a processor-based system to:
automatically access a telephone number of a second party to an ongoing telephone call;
access a first database storing a plurality of records, each record including a name, a telephone number and other information;
search said first database for a record containing said telephone number; and
display a name, number and other information associated with said record.

16. The article of claim 15 wherein said medium stores instructions that enable the system to automatically initiate a search for information related to said record in a second database.

17. The article of claim 16 wherein said medium stores instructions that enable the system to search for said information related to said record in a second database external to said system.

18. The article of claim 17 wherein said medium stores instructions that enable the system to transmit a search query to said second database and receive search results.

19. The article of claim 17 wherein said medium stores instructions that enable the system to automatically store, information related to said record found in said second database, in said first database.

20. The article of claim 16 wherein said medium stores instructions that enable the system to select said second database from a plurality of databases, each of said databases located externally of said system.

21. The article of claim 20 wherein said medium stores instructions that enable the system to access a user preference table that indicates a preferred search hierarchy among the plurality of databases.

22. The article of claim 15 wherein said medium stores instructions that enable the system to store a sequential listing of telephone numbers of outgoing phone calls and caller identification information for incoming telephone calls.
